(19) United States
(12) Patent Application Publication
(10) Pub. No.: US 2008/0253810 A1
(43) Pub. Date: Oct. 16, 2008

(54) DEVELOPING DEVICE, PROCESS CARTRIDGE, AND IMAGE FORMING APPARATUS

(76) Inventors: Susumu Tateyama, Tokyo (JP); Yoshitaka Fujinuma, Tokyo (JP); Koichi Kato, Kanagawa (JP); Kiyonori Tsuda, Kanagawa (JP); Emi Kita, Tokyo (JP); Yuki Oshikawa, Kanagawa (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/059,392

(22) Filed: Mar. 31, 2008

(30) Foreign Application Priority Data
Apr. 4, 2007 (JP) 2007-098281

(51) Int. Cl. G03G 15/08

(52) U.S. Cl. 399/258

(57) ABSTRACT

To provide a relatively small developing device, process cartridge and image forming apparatus that prevent developer, accommodated in a second developer conveying portion for recovering the developer after a developing step, from being pumped up to a developer carrier, and that do not apply a large stress to the developer. A plurality of developer carriers are arranged side-by-side in a direction of gravitational force so as to face an image carrier. The developing device comprises a first developer conveying portion that supplies the developer to a first developer carrier, a second developer conveying portion that recovers the developer separated from the second developer carrier, and a third developer conveying portion that conveys the developer obliquely upward and conveys, to an upstream side in a conveyance direction of the first developer conveying portion, the developer reaching the downstream side in the conveyance direction of the first developer conveying portion and the developer reaching a downstream side in a conveyance direction of the second developer conveying portion.

### BACKGROUND OF THE INVENTION

1. Field of the Invention

The present invention relates to an electrophotographic image forming apparatus such as a copier, a printer, a facsimile device or a compound device thereof, and a developing device and a process cartridge installed in this image forming apparatus. Particularly, the present invention relates to a developing device, a process cartridge and an image forming apparatus that perform a developing step while circulating a developer in a longitudinal direction by means of a plurality of developer conveying portions.

2. Description of the Related Art

Japanese Published Unexamined Patent Application No. 2001-249545 (Prior Art 1) and Japanese Published Unexamined Patent Application No. 2006-243255 (Prior Art 2), for example, each disclose a developing device for performing a developing step while circulating two-component developer consisting of toner and carrier (including a situation where additive or the like is added) in a longitudinal direction in an image forming apparatus such as a copier and a printer.

The developing device of Prior Art 1 is installed with a developing roller (developer carrier, developing magnet roller) that faces an image carrier such as a photosensitive drum and carries developer, a first screw auger (first developer conveying portion) for supplying the developer to the developing roller, a second screw auger (second developer conveying portion) for recovering the developer removed from the developing roller, and a third screw auger (third developer conveying portion) for conveying the developer, which has reached the downstream side in the conveyance direction of the first and second developer conveying portions, obliquely upward to the upstream side in the conveyance direction of the first developer conveying portion. In the first developer conveying portion, as the developer moves in a longitudinal direction, some of the developer is pumped up onto the developing roller by a magnetic pole (pumping magnetic pole) formed on the developing roller. Thereafter, the developer carried by the developing roller is regulated to an appropriate amount by a doctor blade, and then the toner of this two-component developer adheres to a latent image on the photosensitive drum at a position where the developing roller faces the photosensitive drum. On the other hand, the developer carried on the developing roller after a developing step (developer with low toner density) is removed from the developing roller in the upper part of the second developer conveying portion, and then recovered while being conveyed in the longitudinal direction by the second developer conveying portion.

In this manner, the developing device that performs a developing step while circulating the developer in the longitudinal direction can reduce the length in the short side direction of the device compared to the device that performs a developing step while conveying the developer in the short side direction by means of a paddle or the like.

On the other hand, Prior Art 2 discloses a technology of a developing device that performs a developing step while circulating the developer in a longitudinal direction, wherein two developing rollers (developer carrier, developing sleeve) are arranged side-by-side in a direction of gravitational force. In this developing device, the developer is supplied to the upper developing roller by a first developer conveying portion, and the developer removed from the lower developing roller by a second developer conveying portion. Moreover, after the developer that has reached the downstream side in the conveyance direction of the first and second developer conveying portions flows into a third developer conveying portion, the developer that is conveyed horizontally in the longitudinal direction by the third developer conveying portion and has stopped and swollen at the downstream side in the conveyance direction flows into the upstream side in the conveyance direction of the first developer conveying portion via an opening provided in the upper part thereof.

In the developing devices of Prior Art 1 and the like described above, the magnetic pole (pumping magnetic pole) formed in the developing roller acts on the developer (developer obtained after the developing step) accommodated in the second developer conveying portion, whereby the developer with low toner density is pumped up onto the developing roller. This leads to an irregularity or a reduction in the toner density of the developer used in the developing step, and thus a toner image with a uniform and sufficient image density cannot be formed on the photosensitive drum.

These problems has been significant because the surface (bulk) of the developer rises more easily in the vicinity of the opening that allows the developer to flow into the third developer conveying portion that is the downstream side in the conveyance direction of the second developer conveying portion, than the upstream side in the conveyance direction, and thus the developer further approaches the pumping magnetic pole of the developing roller.

In order to cope with the problems described above, there has been considered to dispose the position of the opening, which allows the developer to flow from the second developer conveying portion into the third developer conveying portion, on the outside a magnetizing range in the longitudinal direction of the developing roller. Specifically, there has been considered to distance the developing roller from the area where the surface of the developer easily rises. In this case, however, the length of the developer conveying portion increases in the longitudinal direction, and thus the developing device cannot be downsized.

In addition, in order to cope with the problems described above, there has been considered to dispose the two developing rollers in the direction of gravitational force as in the developing devices of Prior Art 2 and the like and to increase the distance between the second developer conveying portion and the upper developing roller so that the pumping magnetic pole formed in the upper developing roller does not easily act on the developer hosed in the second developer conveying portion. However, in the developing devices of Prior Art 2 and the like, since a large amount of developer is accumulated in the downstream side in the conveyance direction of the third developer conveying portion, there is a possibility of causing a problem that a large stress is applied to the developer and thereby the life of the developer decreases and that the developer adheres in the form of a block.

Technologies relating to the present invention are also disclosed in, e.g., Japanese Published Unexamined Patent Application H03-461116, Japanese Published Unexamined Patent Application H10-026871 and Japanese Published Unexamined Patent Application H11-167260.

### SUMMARY OF THE INVENTION

The present invention has been designed in consideration of these circumstances, and it is an object thereof to provide a relatively small developing device, process cartridge and image forming apparatus that prevent developer accommodated in a second developer conveying portion for recovering the developer after a developing step from being pumped up to a developer carrier, and that places very little pressure on the developer.

In an aspect of the present invention, a developing device accommodates developer having carrier and toner and develops a latent image formed on an image carrier. The developing device comprises a plurality of developer carriers that carry the developer and are arranged side-by-side in a direction of gravitational force so as to face the image carrier; a first developer conveying portion that conveys the developer in a longitudinal direction and supplies the developer to a first developer carrier, of the plurality of developer carriers, which is disposed in the uppermost part in the direction of gravitational force; a second developer conveying portion that conveys the developer in the longitudinal direction and recovers the developer separated from a second developer carrier, of the plurality of developer carriers, which is disposed in the lowermost part in the direction of gravitational force; and a third developer conveying portion that conveys the developer obliquely upward with respect to the longitudinal direction, and conveys, to an upstream side in a conveyance direction of the first developer conveying portion, the developer that reaches a downstream side in the conveyance direction of the first developer conveying portion and the developer that reaches a downstream side in a conveyance direction of the second developer conveying portion.

In another aspect of the present invention, a developing device accommodates developer having carrier and toner and develops a latent image formed on an image carrier. The developing device comprises a developer carrier that carries the developer and faces the image carrier; a first developer conveying portion that conveys the developer in a longitudinal direction and supplies the developer to the developer carrier by means of a magnetic pole formed by the developer carrier; and a second developer conveying portion that conveys the developer in the longitudinal direction and recovers the developer separated from the developer carrier. The second developer conveying portion is disposed away from the magnetic pole by a predetermined distance or more so that the magnetic pole does not act on the developer accommodated in the second developer conveying portion.

In another aspect of the present invention, a process cartridge is installed detachably with respect to an apparatus main body of an image forming apparatus. A developing device accommodates developer having carrier and toner and develops a latent image formed on an image carrier and is integrated with the image carrier. The developing device comprises: a plurality of developer carriers that carry the developer and are arranged side-by-side in a direction of gravitational force so as to face the image carrier; a first developer conveying portion that conveys the developer in a longitudinal direction and supplies the developer to a first developer carrier, of the plurality of developer carriers, which is disposed in the uppermost part in the direction of gravitational force; a second developer conveying portion that conveys the developer in the longitudinal direction and recovers the developer separated from a second developer carrier, of the plurality of developer carriers, which is disposed in the lowermost part in the direction of gravitational force; and a third developer conveying portion that conveys the developer obliquely upward with respect to the longitudinal direction, and conveys, to an upstream side in a conveyance direction of the first developer conveying portion. The developer reaches a downstream side in the conveyance direction of the first developer conveying portion and reaches a downstream side in a conveyance direction of the second developer conveying portion.

In another aspect of the present invention, a process cartridge is installed detachably with respect to an apparatus main body of an image forming apparatus. A developing device accommodates developer having carrier and toner and develops a latent image formed on an image carrier and is integrated with the image carrier. The developing device comprises: a developer carrier that carries the developer and faces the image carrier; a first developer conveying portion that conveys the developer in a longitudinal direction and supplies the developer to the developer carrier by means of a magnetic pole formed by the developer carrier; and a second developer conveying portion that conveys the developer in the longitudinal direction and recovers the developer separated from the developer carrier. The second developer conveying portion is disposed away from the magnetic pole by a predetermined distance or more so that the magnetic pole does not act on the developer accommodated in the second developer conveying portion.

In another aspect of the present invention, an image forming apparatus comprises a developing device which accommodates developer having carrier and toner and develops a latent image formed on an image carrier, and the image carrier. the developing device comprises: a plurality of developer carriers that carry the developer and are arranged side-by-side in a direction of gravitational force so as to face the image carrier; a first developer conveying portion that conveys the developer in a longitudinal direction and supplies the developer to a first developer carrier, of the plurality of developer carriers, which is disposed in the uppermost part in the direction of gravitational force; a second developer conveying portion that conveys the developer in the longitudinal direction and recovers the developer separated from a second developer carrier, of the plurality of developer carriers, which is disposed in the lowermost part in the direction of gravitational force; and a third developer conveying portion that conveys the developer obliquely upward with respect to the longitudinal direction, and conveys, to an upstream side in a conveyance direction of the first developer conveying portion. The developer reaches a downstream side in the conveyance direction of the first developer conveying portion and reaches a downstream side in a conveyance direction of the second developer conveying portion.

In another aspect of the present invention, an image forming apparatus comprises a developing device which accommodates developer having carrier and toner and develops a latent image formed on an image carrier, and the image carrier. The developing device comprises: a developer carrier that carries the developer and faces the image carrier; a first developer conveying portion that conveys the developer in a longitudinal direction and supplies the developer to the developer carrier by means of a magnetic pole formed by the developer carrier; and a second developer conveying portion that conveys the developer in the longitudinal direction and recovers the developer separated from the developer carrier. The second developer conveying portion is disposed away from the magnetic pole by a predetermined distance or more so that the magnetic pole does not act on the developer accommodated in the second developer conveying portion.

### BRIEF DESCRIPTION OF THE DRAWINGS

The above and other objects, features and advantages of the present invention will become more apparent from the following detailed description taken with the accompanying drawings, in which:

FIG. 1 is an entire configuration diagram showing an image forming apparatus according to an embodiment of the present invention;

FIG. 2 is a diagram showing a process cartridge disposed in the image forming apparatus;

FIG. 3 is a diagram showing the constitution of a developing device;

FIG. 4 is a cross-sectional diagram showing a developer conveying portion of the developing device in a longitudinal direction;

FIG. 5 is a cross-sectional diagram showing a Y1-Y1 cross section of the developer conveying portion;

FIG. 6 is a cross-sectional diagram showing a Y2-Y2 cross section of the developer conveying portion;

FIG. 7 is a diagram showing a situation where the developer becomes unbalanced in the developer conveying portion; and

FIG. 8 is a diagram showing a magnetic sensor provided in the developer conveying portion.

### DESCRIPTION OF THE PREFERRED EMBODIMENTS

The best mode for carrying out the present invention will be described hereinafter with reference to the drawings. Note that in each diagram the same reference numerals are applied to the same or equivalent parts, and overlapping explanation thereof will be omitted accordingly.

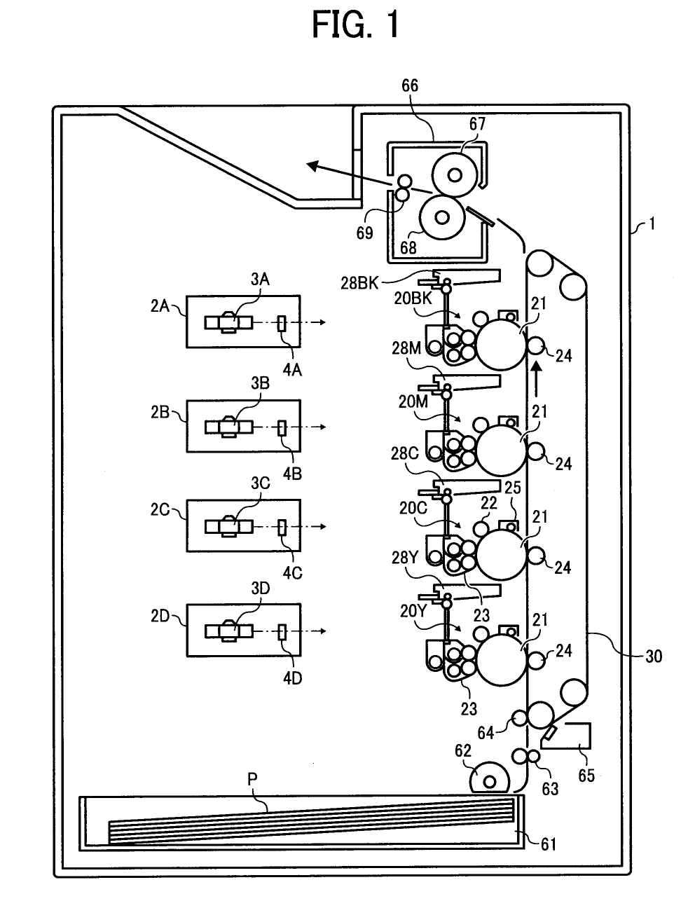

First of all, the configuration/operation of the entire image forming apparatus according to the embodiment is described with reference to FIG. 1.

Writing portions 2A through 2D each are a device for writing an electrostatic latent image to a photosensitive drum 21 (image carrier) on the basis of the image information after a charging step is performed. The writing portions 2A through 2D each are an optical scanning device that uses polygon mirrors 3A through 3D, optical elements 4A through 4D and the like. Note that in place of the optical scanning device, LED arrays can be used as the writing portions.

A sheet feeding portion 61 stores a recording sheet, a transferred material P such as OHP and the like and feeds the transferred material P toward a transfer belt 30 at the time of image formation.

The transfer belt 30 is an endless belt for electrostatically attracting the transferred material P to the surface of the transfer belt 30 and conveying the transferred material P to transfer a toner image formed on the photosensitive drum 21 onto the transferred material P. The transfer belt 30 is provided with an attraction roller 64 and a belt cleaner 65 on an outer peripheral surface of the transfer belt 30.

A transfer roller 24 facing the photosensitive drum 21 via the transfer belt 30 has a cored bar and a conductive elastic layer for coating the cored bar. The conductive elastic layer of the transfer roller 24 is an elastic body obtained by blending and dispersing a conductivity imparting agent such as carbon black, zinc oxide, tin oxide into an elastic material such as polyurethane rubber and ethylene-propylene-diene polyethylene (EPDM) and adjusting the electric resistance value (volume resistivity) to medium resistance.

A fixing portion 66 has a heating roller 68 and a press roller 67 and fixes the toner image formed on the transferred material P to the transfer material P by means of pressure and heat.

Four process cartridges 20Y, 20C, 20M and 20BK disposed vertically along the transfer belt 30 form yellow, cyan, magenta and black toner images respectively.

Note that in the present application the expression “process cartridge” is defined as a unit that is obtained by integrating the image carrier with at least one of a charger for charging the image carrier, a developing portion (developing device) for developing the latent image formed on the image carrier, and a cleaning portion for cleaning the image carrier, and installed so as to be detachable with respect to the image forming apparatus main body.

The process cartridges 20Y, 20C, 20M and 20BK is installed with, respectively, toner cartridges 28Y, 28C, 28M and 28BK for supplying toners (toner particles) of the respective colors (yellow, cyan, magenta and black) to a developing device 23.

The process cartridges 20Y, 20C, 20M and 20BK and the toner cartridges 28Y, 28C, 28M and 28BK can be detached from the apparatus main body 1 by releasing the transfer belt 30 around a rotary support shaft.

The image forming apparatus according to the present embodiment is a compound image forming apparatus that functions as a copier and a printer. When the image forming apparatus is caused to function as a copier, the image information read from a scanner is subjected to various image processes such as A/D conversion, MTF correction and gradation process, and thus obtained image information is converted to write data. When the image forming apparatus is caused to function as a printer, image process is performed on image information described in a page-description language or on bit-mapped image information that is transmitted from a computer or the like, and thus obtained image information is converted to write data.

In image formation, the process cartridges 20BK, 20M, 20C and 20Y are irradiated with exposure light beams corresponding to black, magenta, cyan and yellow image information items from the writing portions 2A through 2D. Specifically, the exposure light beams (laser beams) emitted from respective light sources are transmitted through the polygon mirrors 3A through 3D, optical elements 4A through 4D and the like and radiated onto the photosensitive drums 21 respectively. Accordingly, toner images corresponding to the exposure light beams are formed on the photosensitive drums 21 (image carriers) of the respective process cartridges 20BK, 20M, 20C and 20Y. Then, these toner images are transferred onto the transferred material P.

The transferred material P that is fed from the sheet feeding portion 61 is conveyed to the position of the transfer belt 30 after timed at the position of a resist roller 63. The attraction roller 64 that is disposed at the position where the transfer belt 30 is fed in is attracts the transferred material P, which is fed in by the application of voltage, to the transfer belt 30. The transferred material P that is moved by the traveling of the transfer belt 30 in the direction of the arrow passes the positions of the process cartridges 20Y, 20C, 20M and 20BK successively so that the toner images of the respective colors are superposed on the transferred material P, and the transferred material P is then transferred.

The transferred material P onto which the color toner images are transferred separates from the transfer belt 30 to reach the fixing portion 66. The toner images on the transferred material P are heated between the heating roller 68 and the press roller 67 and thereby fixed to the transferred material P. On the other hand, the surface of the transfer belt 30 reaches the position of the belt cleaner 65 after the transferred material P separates from the transfer belt 30, and toner stain and the like adhered to the surface of the transfer belt 30 is cleaned.

Next, the process cartridges and the toner cartridges of the image forming apparatus will be described in detail.

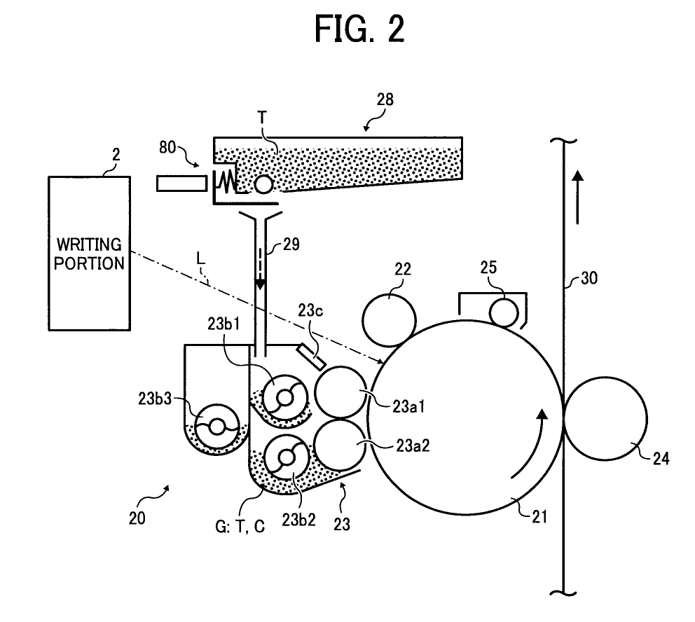

Note that the process cartridges 20Y, 20C, 20M and 20BK have substantially the same structure, and the toner cartridges 28Y, 28C, 28M and 28BK also have substantially the same structure, hence FIG. 2 shows one of each of the process cartridges and toner cartridges without the alphabet (Y, C, M or BK). FIG. 2 also shows one of the writing portions without the alphabet (A through D).

As shown in FIG. 2, the process cartridge 20 has an integration of the photosensitive drum 21 serving as an image carrier, a charger 22, the developing device 23 (developing portion) and a cleaning portion 25.

The photosensitive drum 21 serving as an image carrier is a negatively-charged organic photoreceptor, which is driven to rotate by a rotary drive mechanism, not shown, in the counterclockwise direction.

The charger 22 is an elastic charging roller in which a foam urethane layer with intermediate resistance comprising a urethane resin, carbon black as conductive particles, a sulphidizing agent, a foaming agent and the like is formed on a core metal in the form of a roller. As the material of the intermediate resistance layer of the charger 22, a rubber material in which conductive substances such as carbon black and metallic oxide are dispersed in order to adjust the resistance of urethane, ethylene-propylene-diene polyethylene (EPDM), butadiene-acrylonitrile rubber (NBR), silicone rubber, and isoprene rubber, or a material in which these conductive substances are foamed can be used.

The cleaning portion 25 is installed with a cleaning brush (or a cleaning blade) brought into sliding contact with the photosensitive drum 21, and mechanically removes/recovers untransferred toner remaining on the photosensitive drum 21.

In the developing device 23, a first developing roller 23a1 serving as a first developer carrier and a second developing roller 23a2 serving as a second developer carrier are arranged adjacent to the photosensitive drum 21, and a developing region where the photosensitive drum 21 and magnetic brushes are in contact with each other is formed in the section where the first developing roller 23a1 and the second developing roller 23a2 face each other. Developer G (two-component developer) consisting of toner T and carrier C is accommodated in the developing device 23. Then, the developing device 23 develops the electrostatic latent image formed on the photosensitive drum 21 (forms a toner image). Note that the configuration and operations of the developing device 23 will be described hereinafter in detail.

As shown in FIG. 2, the toner cartridge 28 accommodates the toner T that is supplied into the developing device 23. Specifically, the opening/closing operation of a shutter mechanism 80 is performed based on the information on toner density (ratio of the toner within the developer G) detected by a magnetic sensor (not shown) installed in the developing device 23, and accordingly the toner T is supplied appropriate from the toner cartridge 28 into the developing device 23.

A feed pipe 29 is used for accurately guiding the toner T supplied from the toner cartridge 28 into the developing device 23. Specifically, the toner T that is discharged from the toner cartridge 28 is supplied to the developing device 23 via the feed pipe 29.

Next, image creation processes performed by the photosensitive drum 21 is described.

As shown in FIG. 2, once the photosensitive drum 21 is driven to rotate in the counterclockwise direction, first the surface of the photosensitive drum 21 is charged uniformly at the position of the charger 22. Thereafter, the charged surface of the photosensitive drum 21 reaches the position irradiated with an exposure light beam L, and is then subjected to an exposure step by the writing portion 2. Specifically, the surface of the photosensitive drum 21 is selectively destaticized according the image information by the irradiation of the exposure light beam L, whereby a difference (potential contrast) is generated between the potential of the photosensitive drum 21 and the potential of a non-mage portion, not irradiated, to form an electrostatic latent image. Note that in this exposure step the charge generating substances within the photosensitive layer of the photosensitive drum 21 receive the light beam to generate charges, among which the electron holes and the electrification charges of the surface of the photosensitive drum 21 cancel out each other.

Thereafter, the surface of the photosensitive drum 21 on which the latent image is formed reaches the position where the photosensitive drum 21 faces the developing device 23. The electrostatic latent image formed on the photosensitive drum 21 is brought into contact with the magnetic brushes of the first developing roller 23a1 and the second developing roller 23a2, whereby negatively charged toner T within each magnetic brush adheres to the electrostatic latent image so as to make the electrostatic latent image visible.

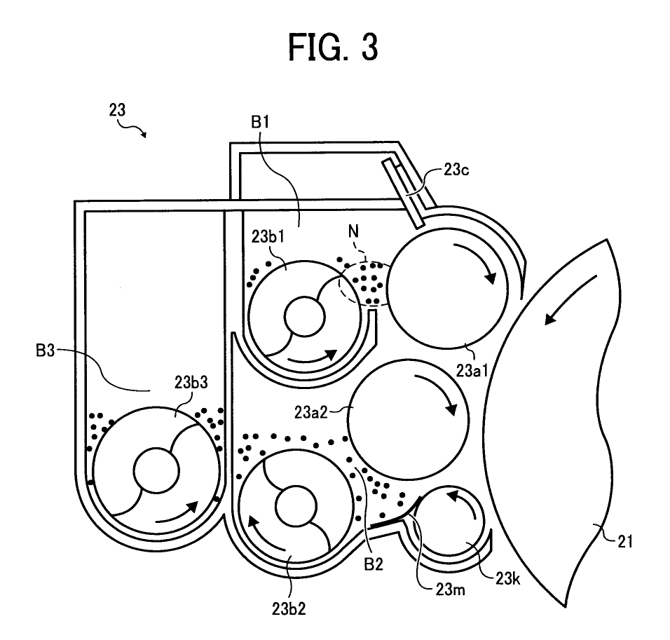

More specifically, the developer G that is pumped up by the magnetic force of a magnetic pole (the pumping magnetic pole N shown in FIG. 3) of the first developing roller 23a1 (first developer carrier) is regulated to an appropriate amount by a doctor blade 23c, and is then conveyed to the developing region, which is a facing portion facing the photosensitive drum 21 (a facing region where the two developing rollers 23a1, 23a2 face the photosensitive drum 21). The napped carrier C in the developing region rubs the photosensitive drum 21. At this moment, the toner T mixed with the carrier C is negatively charged by the friction with the carrier C. The carrier C, on the other hand, is charged positively. A predetermined developing bias is applied to the two developing rollers 23a1, 23a2 by a power source portion, not shown. Accordingly, an electric field is formed between the photosensitive drum 21 and the two developing rollers 23a1, 23a2, and the negatively charged toner T is selectively caused to adhere to an image portion on the photosensitive drum 21 by the electric field, to form a toner image.

Thereafter, the surface of the photosensitive drum 21 on which the toner image is formed reaches a facing position where the transfer belt 30 and the transfer roller 24 face each other. Then, at this timing, the toner image formed on the photosensitive drum 21 is transferred onto the transferred material P that is conveyed to this facing position. At this time, the transfer roller 24 is applied with a predetermined voltage.

Thereafter, the transferred material P onto which the toner image is transferred is discharged from a discharge roller 69 to the outside of the apparatus via the fixing portion 66.

On the other hand, the toner T that remains on the photosensitive drum 21 without being transferred to the transferred material P during the transfer step (untransferred toner) reaches a facing portion between the photosensitive drum 21 and the cleaning portion 25 while being adhered to the photosensitive drum 21. Then, the untransferred toner on the photosensitive drum 21 is removed/recovered by the cleaning portion 25.

Thereafter, the surface of the photosensitive drum 21 passes through a destaticizing portion, not shown, and a series of image creation processes of the photosensitive drum 21 ends.

Hereinafter, the configuration and operations of the developing device that are characteristic of the image forming apparatus are described in detail.

As shown in FIG. 3, the developing device 23 is configured by the developing rollers 23a1, 23a2 serving as the developer carriers, conveyance screws 23b1 through 23b3 (auger screws), the doctor blade 23c, a carrier collecting roller 23k, scraper 23m, and the like. Furthermore, three developer conveying portions B1 through B3 for conveying the developer G to form a circulating path are formed within the developing device 23.

In the present embodiment, the two developing roller 23a1, 23a2 (developer carriers) are arranged in the direction of gravitational force (the rotational direction of the photosensitive drum 21) so as to face the photosensitive drum 21. Of the two developing rollers, the first developing roller 23a1 serving as the first developer carrier is disposed in the uppermost part in the direction of gravitational force (upstream side in the rotational direction of the photosensitive drum 21). Of the two developing rollers, the second developing roller 23a2 serving as the second developer carrier is disposed in the lowermost part in the direction of gravitational force (downstream side in the rotational direction of the photosensitive drum 21). The first developing roller 23a1 and second developing roller 23a2 are configured such that sleeves thereof obtained by forming a nonmagnetic body made of aluminum, brass, stainless or conductive resin into a cylindrical shape are rotated in the clockwise direction by the rotary drive mechanism, not shown. Within each of the sleeves of the developing rollers 23a1, 23a2 is fixedly provided a magnet for forming an electric field so that the developer G is napped on the peripheral surface of the sleeve. The carrier C within the developer G is napped in the form of a chain along a line of magnetic force of the magnet in the normal direction. The charged toner T adheres to the carrier C napped in the form of a chain, whereby the magnetic brushes are formed. The magnetic brushes are transported by the rotation of the sleeves in the same direction as the direction of the sleeve. Note that, as shown in FIG. 3, the first developing roller 23a1 has formed therein the pumping magnetic pole N (one of a plurality of magnetic poles) that uses the provided magnet to pump up the developer accommodate in the first developer accommodating portion B1.

The doctor blade 23c is disposed on an upstream side of the developing device to regulate the developer on the first developing roller 23a1 to an appropriate amount.

The three conveyance screws 23b1 through 23b3 rotate in the direction of the arrows shown in FIG. 3, to agitate/mix the developer G accommodated in the developing device 23 while circulating the developer G in the longitudinal direction (direction perpendicular to a paper surface in FIG. 2).

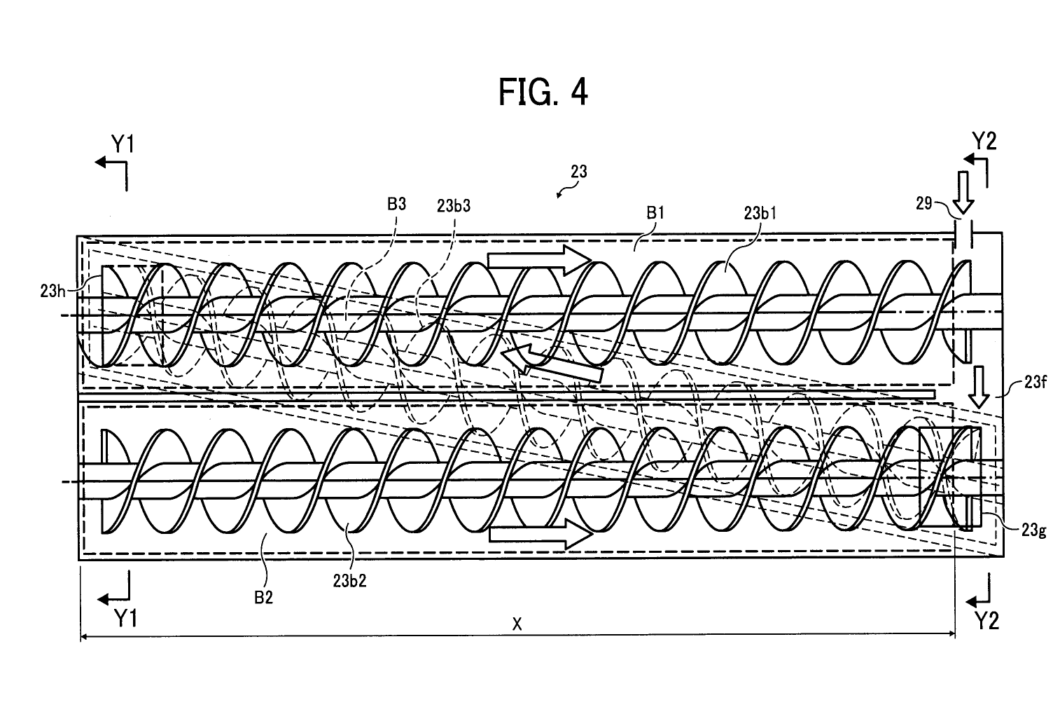

The first conveyance screw 23b1 is disposed in the position of the first developer conveying portion B to face the first developing roller 23a1. The first conveyance screw 23b1 conveys the developer G in the horizontal direction (conveys to the right as shown by a white arrow in FIG. 4), and supplies the developer G onto the first developing roller 23a1. In other words, the first developer conveying portion B1, facing the first developing roller 23a1, conveys and supplies the developer G to the first developing roller 23a1 in the longitudinal direction (direction of a rotary shaft of the first developing roller 23a1).

The second conveyance screw 23b2 is installed in the second developer conveying portion B2. The second conveyance screw 23b2 is disposed in a position below the first conveyance screw 23b1 and faces the second developing roller 23a2. Furthermore, the second conveyance screw 23b2 conveys the developer G separated therefrom (the developer G that is forced to separate from the second developing roller 23a2 by a developer separation pole after a developing step) in the horizontal direction (conveys the developer G to the right as shown by the white arrow in FIG. 4). In other words, the second developer conveying portion B2 is disposed in a position below the first developer conveying portion B1 to face the second developing roller 23a2, and conveys (recovers) the developer G, which is separated from the second developing roller 23a2, in the longitudinal direction.

The first conveyance screw 23b1 and the second conveyance screw 23b2 are disposed such that their rotary shafts are placed substantially horizontally, as with the two developing rollers 23a1, 23a2.

The third conveyance screw 23b3 is disposed in the third developer conveying portion B3. The third conveyance screw 23b3 is disposed obliquely to the horizontal direction so as to linearly connect a downstream side of a conveyance path of the second conveyance screw 23b2 to an upstream side of a conveyance path of the first conveyance screw 23b1 (see FIG. 4). Furthermore, the third conveyance screw 23b3 conveys the developer G, conveyed by the second conveyance screw 23b2, to the upstream side of the conveyance path of the first conveyance screw 23b1, and further conveys the developer G, which flows from the downstream side of the conveyance path of the first conveyances crew 23b1 via a falling path 23f and an opening 23g, to the upstream side of the conveyance path of the first conveyance screw 23b1 (conveys obliquely upward to the left, as shown by the other white arrow in FIG. 4). In other words, the third developer conveying portion B3 conveys the developer G, conveyed by the second developer conveying portion B2, to the upstream side of the first developer conveying portion B1, and further conveys the developer G, which has reached the downstream side of the first developer conveying portion B1, to the upstream side of the first developer conveying portion B1. The direction of the conveyance of the developer G in the third developer conveying portion B3 is angled obliquely upward with respect to the longitudinal direction (horizontal direction).

Note that the conveyance path of the first conveyance screw 23b1 (first developer conveying portion B1), the conveyance path of the second conveyance screw 23b2 (second developer conveying portion B2), and a conveyance path of the third conveyance screw 23b3 (third developer conveying portion B3) are isolated from one another by wall portions.

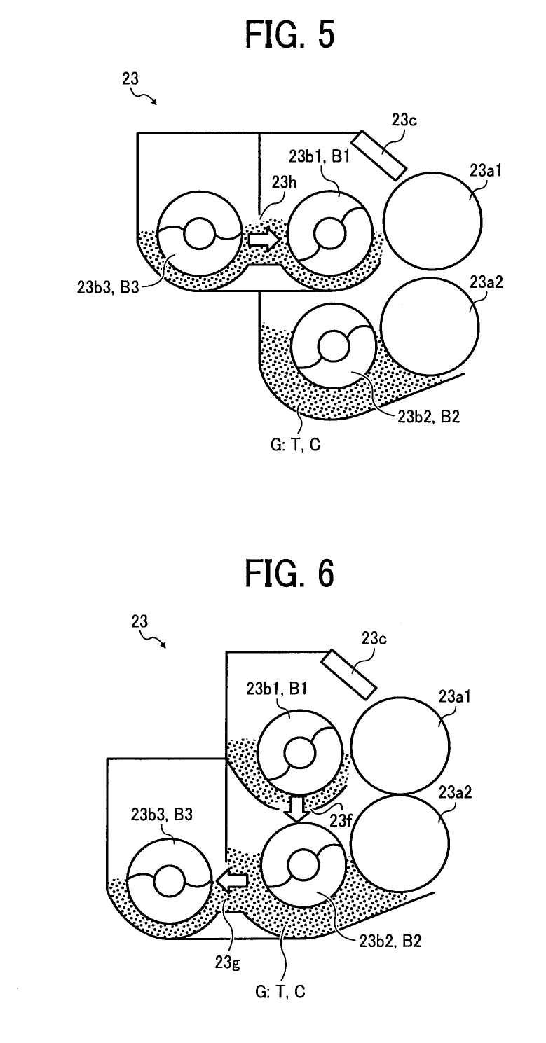

As shown in FIG. 4 and FIG. 5, the downstream side of the third developer conveying portion B3 and the upstream side of the first developer conveying portion B1 are communicated with each other via an opening 23h (second relaying portion). Moreover, as shown in FIG. 4 and FIG. 6, the downstream side of the second developer conveying portion B2 and the upstream side of the third developer conveying portion B3 are communicated with each other via the opening 23g (first relaying portion). In addition, as shown in FIG. 4 and FIG. 6, the downstream side of the first developer conveying portion B1 and the downstream side of the second developer conveying portion B2 are communicated with each other via the falling path 23f.

As shown in FIG. 4, the toner is supplied from the feed pipe 29 to the downstream side of the first developer conveying portion B1, delivered to the second developer conveying portion B2 via the opening 23f while being mixed with the developer within the first developer conveying portion, and then delivered to the third developer conveying portion via the opening 23g. Accordingly, new toner can be agitated and mixed with the developer smoothly within the developing device.

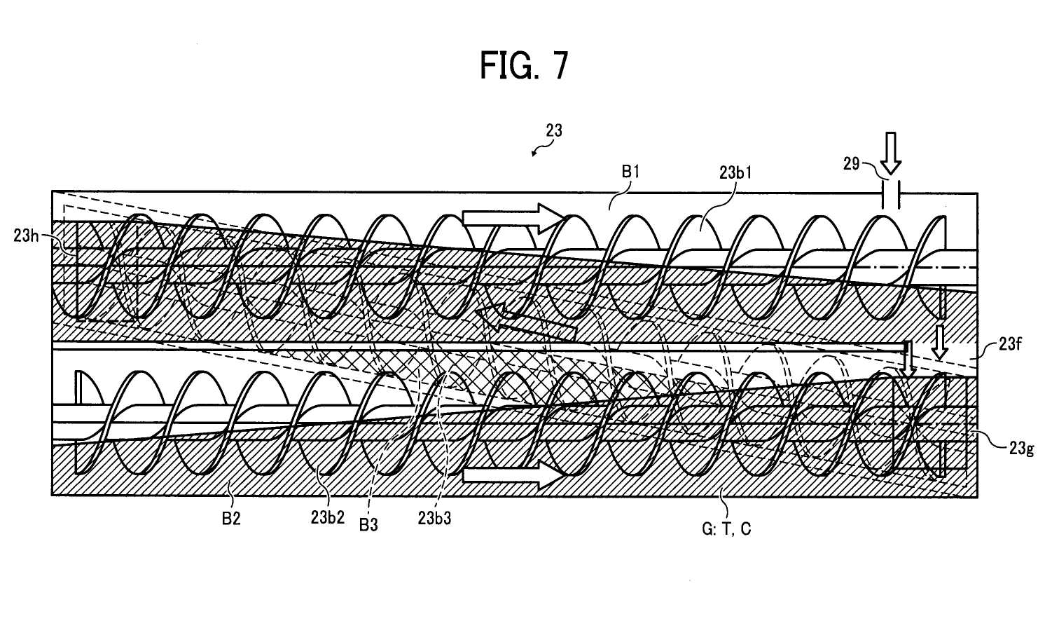

By this configuration, the circulating path for circulating the developer G in the longitudinal direction in the developing device 23 is formed by the three developer conveying portions B1 through B3 (conveyance screws 23b1 through 23b3). Here, when the developing device 23 is activated, the developer accommodated therein flows in a manner shown by the shaded area in FIG. 7. As shown in FIG. 7, the surface of the developer is lower on the downstream side of the first developer conveying portion B1 than that on the upstream side because some of the developer is supplied to the first developing roller 23a1 during the conveyance. Specifically, the developer that is not supplied to the first developing roller 23a1 falls on the downstream side of the second developer conveying portion B2 via the falling path 23f and then flows into the upstream side of the third developer conveying portion B3 via the opening 23g. Furthermore, the surface of the developer is higher on the downstream side of the second developer conveying portion B2 than that on the upstream side because the developer G that is separated from the second developing roller 23a2 (the developer obtained after the developing step) accumulates on the downstream side.

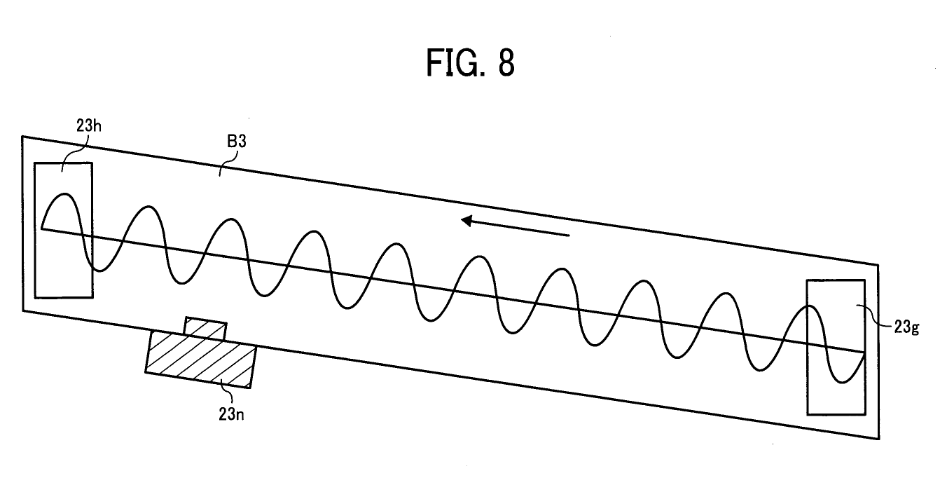

Note that a magnetic sensor 23n is installed in the conveying portion that is closer to the opening 23h of the third developer conveying portion B3 than the opening 23g of the same, as shown in FIG. 8. It is more preferred that the magnetic sensor 23n be disposed in the vicinity of the opening 23h. Accordingly, the magnetic sensor 23n can sense the density of the developer in which the newly supplied toner is mixed well, improving the reliability of the result of the sensing operation. Then, an appropriate amount of toner T is supplied from the toner cartridge 28 to the developing device 23 on the basis of the information on the toner density detected by the magnetic sensor 23n. In the present embodiment the toner density of the developer G within the developing device 23 is controlled to 4 through 7 wt %.

A sufficient effect can be obtained by simply configuring either the position of the feed pipe 29 or the position of the magnetic sensor 23n as described above, but configuring both enables more accurate detection of the developer density in which the toner is mixed and agitated well.

Here, as shown in FIG. 3 (not shown in FIG. 2 and others), in the present embodiment the carrier collecting roller 23k is installed in a position below the second developing roller 23a2 (downstream side in the rotational direction) so as to face the photosensitive drum 21. Furthermore, the scraper 23m is installed in a position abutting against the carrier collecting roller 23k.

The carrier collecting roller 23k is configured by fixedly providing a magnet that forms a predetermined magnetic field in a cylinder body made of stainless or the like, and is used for collecting the carrier that move (flies) from the interior of the developing device 23 and adheres to the photosensitive drum 21. The carrier collecting roller 23k is driven to rotate in the counterclockwise direction of FIG. 3. Most of the carrier that is collected and carried by the carrier collecting roller 23k is transported onto the developing roller 23a2 at a position where the carrier collecting roller 23k faces the second developing roller 23a2, and separated from the second developing roller 23a2 at the position of the developer separation pole of the developing roller 23a2, and then recovered into the second developer conveying portion B2. On the other hand, the carrier that is not transported onto the second developing roller 23a2 and thereby remains to be carried on the carrier collecting roller 23k is mechanically scraped off by the scraper 23m and recovered into the second developer conveying portion B2. By installing the carrier collecting roller 23k in this manner, the carrier adhered to the photosensitive drum 21 can be recovered into the developing device 23, whereby the generation of an abnormal image (splattered image, white image etc.) and the carrier can be prevented from lacking in the developing device 23.

Note that, in the present embodiment, the outer diameter of each of the developing rollers 23a1, 23a2 is set at approximately 30 mm, the linear velocity on an outer peripheral surface of each of the developing rollers 23a1, 23a2 at approximately 748 mm/sec, the outer diameter of the carrier collecting roller 23k at approximately 16 mm, the linear velocity on an outer peripheral surface of the carrier collecting roller 23k at approximately 10.6 mm/sec, and the process linear velocity (linear velocity on an outer peripheral surface of the photosensitive drum 21 and the conveyance speed of the transferred material P) at approximately 440 mm/sec.

Moreover, the carrier C used in the present embodiment has a particle diameter of approximately 55 μm and a saturation magnetization of approximately 96 emu/g. In addition, the toner T used in the present embodiment has a particle diameter of approximately 6.8 μm.

Therefore, in the present embodiment the second developer conveying portion B2 is disposed away from the pumping magnetic pole N of the first developing roller 23a1 by a predetermined distance or more so that the pumping magnetic pole N (the other magnetic pole as well) does not act on the developer accommodated in the second developer conveying portion B2. Specifically, the second developing roller 23a2 is disposed below the first developing roller 23a1 having the pumping magnetic pole N (the pumping magnetic pole is not formed in the second developing roller 23a2), and the second developer conveying portion B2 is disposed at a position facing the second developing roller 23a2, whereby the second developer conveying portion B2 is disposed largely apart from the pumping magnetic pole N. Therefore, even when the surface (bulk) of the developer rises in the vicinity of the opening 23g disposed on the downstream side in the conveyance direction of the second developer conveying portion, the developer with a low toner density (the developer of the second developer conveying portion B2) is prevented from being transported onto the first developing roller 23a1 because the distance between the developer in the vicinity of the opening 23g and the pumping magnetic pole N is sufficiently large.

Furthermore, for the above reason, in the present embodiment the falling path 23f and the opening 23g do not have to be disposed outside a magnetized area X in the longitudinal direction of the developing rollers 23a1, 23a2 as shown in FIG. 4, whereby the developing device can be downsized without increasing the size of the developer conveying portions B1 through B3 in the longitudinal direction more than necessary.

Note that in the present embodiment the two developing rollers (image carriers) are disposed in the direction of gravitational force, but three or more of the developing rollers can be disposed in the direction of gravitational force (the rotational direction of the photosensitive drum 21). In this case, the second developer conveying portion B2 facing the lowermost developing roller can be disposed further apart from the pumping magnetic pole N of the uppermost developing roller, hence the effect of preventing the abovementioned developer from being transported can be further improved.

In addition, in the present embodiment the third developer conveying portion B3 is configured such as to convey the developer obliquely upward with respect to the horizontal direction (longitudinal direction) instead of being configured as a horizontal path. Therefore, compared to the configuration in which the third developer conveying portion is configured horizontally to accumulate a large amount of developer on the downstream side thereof and cause the raised developer to flow into the first developer conveying portion, it is possible to prevent the life of the developer from being reduce by the application of a large stress thereon and to prevent the developer from fixedly adhering in the form of a block. Specifically, the plurality of developer conveying portions B1 through B3 can conduct a smooth conveyance of the developer.

Note that because this effect prevents the pumping magnetic pole N from acting on the developer contained in the second developer conveying portion B2, this effect becomes prominent particularly when the difference in height between the first developer conveying portion B1 and the second developer conveying portion B2 is increased.

Specifically, when the difference in height between the first developer conveying portion B1 and the second developer conveying portion B2 becomes large by increasing the number of developing rollers to two or three, in a configuration in which a large amount of developer is accumulated in the downstream side of the third developer conveying portion disposed horizontally and then the raised developer is caused to flow into the first developer conveying portion, a great deal of accumulation needs to be generated on the downstream side of the third developer conveying portion, causing an even larger stress on the developer. However, when the third developer conveying portion B3 is configured obliquely, the developer can be conveyed smoothly without applying a large stress thereto, even when the difference in height between the first developer conveying portion B1 and the second developer conveying portion B2 becomes large by increasing the number of developing rollers to two or three.

As described above, the present embodiment is configured such that the pumping magnetic pole N (magnetic pole) of the first developing roller 23a1 (the first developer carrier) does not act on the developer G accommodated in the second developer conveying portion B2 that recovers the developer G after the developing step. The present embodiment also optimizes the developer conveying portions B1 through B3 of the developer G in the longitudinal direction. Accordingly, the developer G accommodated in the second developer conveying portion B2 is prevented from being pumped up to the first developing roller 23a1, the size of the device can be made relatively small, and stress applied to the developer G can be reduced.

Note in the present embodiment that although the present invention is applied to the developing device 23 installed with the three developer conveying portions B1 through B3, the present invention can be applied to a developing device installed with four or more developer conveying portions. In this case as well, the effects similar to those of the present embodiment can be achieved by disposing at least one of the plurality of developer conveying portions obliquely to the horizontal direction.

Moreover, although only the toner T is supplied from the toner cartridge 28 toward the developing device 23 according to the present embodiment, the developer G (toner T and carrier C) can be accommodated in the toner cartridge 28 and supplied toward the developing device 23. In this case, a mechanism for discharging the carrier (deteriorated carrier) appropriately from the developing device 23 is provided. The effects similar to those of the present embodiment can be achieved even when employing such a trickle developing system (a developing system for replenishing and discharging the carrier appropriately).

In addition, in the present embodiment the present invention is applied to the image forming apparatus in which a part of an image creating portion is configured by the process cartridges 20. However, the present invention is applied not only to this image forming apparatus but also an image forming apparatus in which the image creating portion thereof is not formed into a process cartridge. Specifically, the present invention can be applied even when the developing device 23 is an independent unit that is detachable with respect to the image forming apparatus. In this case as well, the effects similar to those of the present embodiment can be achieved.

Note that the present invention is not limited to the present embodiment, and it is evident that the present embodiment can be modified appropriately from the suggestions provided in the present embodiment within the scope of the technical concept of the present invention. Moreover, the number, positions, shapes and the like of the components described above are not limited to the present embodiment and thus can be changed to preferred number, positions, shapes and the lie when implementing the present invention.

As described above, the present invention is configured such that the magnetic pole of the developer carrier is prevented from acting on the developer accommodated in the second developer conveying portion that recovers the developer after the developing step, and further optimizes the circulation paths of the developer in the longitudinal direction. Therefore, it is possible to provide a relatively small developing device, process cartridge, and image forming apparatus that prevent the developer, accommodated in the second developer conveying portion, from being pumped up to the developer carrier, and that do not apply a large stress to the developer.

Various modifications will become possible for those skilled in the art after receiving the teachings of the present disclosure without departing from the scope thereof.

What is claimed is:

1. A developing device, which accommodates developer having carrier and toner and develops a latent image formed on an image carrier, the developing device comprising:
a plurality of developer carriers that carry the developer and are arranged side-by-side in a direction of gravitational force so as to face the image carrier;
a first developer conveying portion that conveys the developer in a longitudinal direction and supplies the developer to a first developer carrier, of the plurality of developer carriers, which is disposed in the uppermost part in the direction of gravitational force;
a second developer conveying portion that conveys the developer in the longitudinal direction and recovers the developer separated from a second developer carrier, of the plurality of developer carriers, which is disposed in the lowermost part in the direction of gravitational force; and
a third developer conveying portion that conveys the developer obliquely upward with respect to the longitudinal direction, and conveys, to an upstream side in a conveyance direction of the first developer conveying portion, the developer that reaches a downstream side in the conveyance direction of the first developer conveying portion and the developer that reaches a downstream side in a conveyance direction of the second developer conveying portion.

2. The developing device as claimed in claim 1, further comprising a falling path that causes the developer reaching the downstream side in the conveyance direction of the first developer conveying portion to fall on the downstream side in the conveyance direction of the second developer conveying portion, wherein the downstream side in the conveyance direction of the second developer conveying portion and an upstream side in a conveyance direction of the third developer conveying portion are communicated with each other.

3. A developing device, which accommodates developer having carrier and toner and develops a latent image formed on an image carrier, the developing device comprising:
a developer carrier that carries the developer and faces the image carrier;
a first developer conveying portion that conveys the developer in a longitudinal direction and supplies the developer to the developer carrier by means of a magnetic pole formed by the developer carrier; and
a second developer conveying portion that conveys the developer in the longitudinal direction and recovers the developer separated from the developer carrier,
wherein the second developer conveying portion is disposed away from the magnetic pole by a predetermined distance or more so that the magnetic pole does not act on the developer accommodated in the second developer conveying portion.

4. The developing device as claimed in claim 3, wherein the developer carrier comprises a plurality of developer carriers that are arranged side-by-side in a direction of gravitational force so as to face the image carrier, the first developer conveying portion is installed so as to face a first developer carrier, of the plurality of developer carriers, which is disposed in the uppermost part in the direction of gravitational force and forms the magnetic pole, and the second developer conveying portion is installed so as to face a second developer carrier, of the plurality of developer carriers, which is disposed in the lowermost part in the direction of gravitational force.

5. The developing device as claimed in claim 3, further comprising:
a falling path that causes the developer reaching a downstream side in a conveyance direction of the first developer conveying portion to fall on a lower part in the direction of gravitational force; and
a third developer conveying portion that conveys the developer obliquely upward with respect to the longitudinal direction, causes the developer falling through the falling path and the developer reaching a downstream side in a conveyance direction of the second developer conveying portion to flow through an opening, and conveys the developers to an upstream side in the conveyance direction of the first developer conveying portion.

6. A process cartridge, which is installed detachably with respect to an apparatus main body of an image forming apparatus, wherein a developing device, which accommodates developer having carrier and toner and develops a latent image formed on an image carrier, is integrated with the image carrier, and wherein the developing device comprises:
a plurality of developer carriers that carry the developer and are arranged side-by-side in a direction of gravitational force so as to face the image carrier;
a first developer conveying portion that conveys the developer in a longitudinal direction and supplies the developer to a first developer carrier, of the plurality of developer carriers, which is disposed in the uppermost part in the direction of gravitational force;
a second developer conveying portion that conveys the developer in the longitudinal direction and recovers the developer separated from a second developer carrier, of the plurality of developer carriers, which is disposed in the lowermost part in the direction of gravitational force; and
a third developer conveying portion that conveys the developer obliquely upward with respect to the longitudinal direction, and conveys, to an upstream side in a conveyance direction of the first developer conveying portion, the developer that reaches a downstream side in the conveyance direction of the first developer conveying portion and the developer that reaches a downstream side in a conveyance direction of the second developer conveying portion.

7. A process cartridge, which is installed detachably with respect to an apparatus main body of an image forming apparatus, wherein a developing device, which accommodates developer having carrier and toner and develops a latent image formed on an image carrier, is integrated with the image carrier, and wherein the developing device comprises:
a developer carrier that carries the developer and faces the image carrier;
a first developer conveying portion that conveys the developer in a longitudinal direction and supplies the developer to the developer carrier by means of a magnetic pole formed by the developer carrier; and
a second developer conveying portion that conveys the developer in the longitudinal direction and recovers the developer separated from the developer carrier, the second developer conveying portion being disposed away from the magnetic pole by a predetermined distance or more so that the magnetic pole does not act on the developer accommodated in the second developer conveying portion.

8. An image forming apparatus, comprising a developing device, which accommodates developer having carrier and toner and develops a latent image formed on an image carrier, and the image carrier, wherein the developing device comprises:
a plurality of developer carriers that carry the developer and are arranged side-by-side in a direction of gravitational force so as to face the image carrier;
a first developer conveying portion that conveys the developer in a longitudinal direction and supplies the developer to a first developer carrier, of the plurality of developer carriers, which is disposed in the uppermost part in the direction of gravitational force;
a second developer conveying portion that conveys the developer in the longitudinal direction and recovers the developer separated from a second developer carrier, of the plurality of developer carriers, which is disposed in the lowermost part in the direction of gravitational force; and
a third developer conveying portion that conveys the developer obliquely upward with respect to the longitudinal direction, and conveys, to an upstream side in a conveyance direction of the first developer conveying portion, the developer that reaches a downstream side in the conveyance direction of the first developer conveying portion and the developer that reaches a downstream side in a conveyance direction of the second developer conveying portion.

9. An image forming apparatus, comprising a developing device, which accommodates developer having carrier and toner and develops a latent image formed on an image carrier, and the image carrier, wherein the developing device comprises:
a developer carrier that carries the developer and faces the image carrier;
a first developer conveying portion that conveys the developer in a longitudinal direction and supplies the developer to the developer carrier by means of a magnetic pole formed by the developer carrier; and
a second developer conveying portion that conveys the developer in the longitudinal direction and recovers the developer separated from the developer carrier, the second developer conveying portion being disposed away from the magnetic pole by a predetermined distance or more so that the magnetic pole does not act on the developer accommodated in the second developer conveying portion.
